(19) United States
(12) Patent Application Publication
(10) Pub. No.: US 2014/0162045 A1
(43) Pub. Date: Jun. 12, 2014

(54) RADIATION STABILIZED PVC COMPOSITIONS, AND METHOD OF MAKING SAME

(71) Applicants: BAXTER HEALTHCARE SA, Glattpark (Opifkon) (CH); BAXTER INTERNATIONAL INC., Deerfield, IL (US)

(72) Inventors: Anthony Bourassa, Grayslake, IL (US); Vadim V. Krongauz, Bartlett, IL (US); Yann-Per Lee, Vernon Hills, IL (US); Michael Tung-Kiung Ling, Vernon Hills, IL (US); Richard J. Mennenoh, McHenry, IL (US); Zehra Sibel Sevinc, Round Lake Beach, IL (US)

(73) Assignees: BAXTER HEALTHCARE SA, Glattpark (Opifkon) (CH); BAXTER INTERNATIONAL INC., Deerfield, IL (US)

(21) Appl. No.: 14/102,831

(22) Filed: Dec. 11, 2013

Related U.S. Application Data
(60) Provisional application No. 61/735,888, filed on Dec. 11, 2012.

(51) Int. Cl. C08L 91/06; C08L 23/06; C08K 5/1515; C08L 27/06; C08K 5/12; C08K 5/098

(52) U.S. Cl. CPC C08L 91/06; C08K 5/12; C08K 5/098; C08K 5/1515; C08L 27/06; C08L 23/06
USPC 428/220; 522/155; 524/287

(57) ABSTRACT

Disclosed are PVC compositions with enhanced color resistance to electromagnetic irradiation & shelf life color stability; gamma-irradiated PVC articles; methods of making the gamma-irradiated PVC articles; and compositions including PVC resins for making the gamma-irradiated PVC articles.

### CROSS-REFERENCE TO RELATED APPLICATION

The benefit under 35 U.S.C. §119(e) of U.S. Provisional Patent Application Ser. No. 61/735,888 filed Dec. 11, 2012, is hereby claimed, and the disclosure thereof is hereby incorporated by reference herein.

### FIELD OF THE DISCLOSURE

The present disclosure relates generally to polyvinyl chloride (PVC) compositions. More particularly, the disclosure relates to PVC compositions with enhanced color resistance to electromagnetic irradiation & shelf life color stability.

### BACKGROUND

Polyvinyl chloride (PVC) compositions, and articles made therefrom, are well known in the art. Particularly, a variety of medical devices are formed out of PVC. An effective method for the sterilization of such medical devices is exposure of the device to gamma-radiation. However, upon exposure to heat or electromagnetic radiation, including ultraviolet, electron beam, X-ray and gamma radiation, polyvinyl chloride articles may eventually alter their appearance and in particular their color.

The alteration in appearance of an irradiated PVC material is generally in one and/or two general visually noticeable areas. The first alteration in appearance is when the material appears to become more yellow. The second alteration in appearance is where there is a distinct color change for example to display more blue or green. This alteration in appearance may be fairly immediate or may occur over a longer period of time extending several weeks or months. When the PVC material is used in the molding of articles in medical devices, the alteration in appearance may cause the user of the device to believe it is no longer suitable for use. Because medical devices may be sold with a relatively long shelf life, having even a slight color change between the recently purchased products and those that have been in inventory longer will be especially noticeable and lead to complaints. Although it is known to attempt to minimize the alteration in appearance by UV bleaching, this process appears insufficient in minimizing the level of appearance alteration.

The discoloration of PVC upon exposure to heat or radiation is due to degradation of the PVC. The major degradation products responsible for coloration are conjugated polyenes that form due to dehydrochlorination. Conjugated polyenes are yellowish-red due to absorption in the blue region of the visible light spectrum. Once the dehydrochlorination is initiated, the released hydrochloric acid (HCl) contributes to further dehydrochlorination and discoloration of the PVC.

### SUMMARY

One aspect of the disclosure is a gamma-irradiated polyvinyl chloride (PVC) article, including a mixture of a PVC resin, a primary plasticizer present in an amount of about 30 to about 60 phr and a metal-carboxylate acid scavenger present in an amount of about 0.01 to about 0.5 phr.

Another aspect of the disclosure is a method of making a gamma-irradiated PVC article, including the steps of providing a PVC article including a mixture of a PVC resin, a primary plasticizer present in an amount of about 30 phr to about 60 phr and a metal-carboxylate acid scavenger present in an amount of about 0.01 to about 0.5 phr, and exposing the PVC article to gamma radiation in an amount in a range of about 10 KGy to about 100 KGy.

Another aspect of the disclosure is a PVC article, including a mixture of a PVC resin, a primary plasticizer present in an amount of about 25 to about 55 phr, and an inorganic colorant in an amount of at least about 0.008 phr and optionally less than 0.15 phr. Optionally, the PVC article is gamma-irradiated.

Another aspect of the disclosure is a method of making a gamma-irradiated PVC article, including the steps of providing a PVC article including a mixture of a PVC resin, a primary plasticizer present in an amount of about 30 to about 60 phr, and an inorganic colorant in an amount of at least about 0.008 phr and optionally less than 0.15 phr, and exposing the PVC article to gamma radiation in an amount in a range of about 10 KGy to about 100 KGy.

For the compositions and methods described herein, optional features, including but not limited to components, compositional ranges thereof, substituents, conditions, and steps, are contemplated to be selected from the various aspects, embodiments, and examples provided herein.

Further aspects and advantages will be apparent to those of ordinary skill in the art from a review of the following detailed description. While the compositions and methods are susceptible of embodiments in various forms, the description hereafter includes specific embodiments with the understanding that the disclosure is illustrative, and is not intended to limit the invention to the specific embodiments described herein.

### FIGURES

The patent or application file contains at least one drawing executed in color. Copies of this patent or patent application publication with color drawing(s) will be provided by the Office upon request and payment of the necessary fee.

FIG. 1 shows a plot of the change in color vs. time post-sterilization (in weeks) for molded PVC articles sterilized with 27 KGy Gamma radiation and aged at 57° C. and comprised of a commercially-available, medical grade Control PVC (hot runner mold), the medical grade Control PVC (cold runner mold), DEHP-free PVC with 5 ppm Co/Al oxide inorganic pigment, and the medical grade Control DEHP-free PVC with 50 ppm Co/Al oxide inorganic pigment.

FIG. 2 shows a plot of PVC part color change in the presence of different colorants. This plot shows indicates that PVC compositions with organometallic colorant after gamma radiation exposure became yellower to a great extent following accelerated aging at 57° C. while PVC compositions with inorganic colorant retained their original color.

FIGS. 3(a)-3(c) show plots of PVC part yellowness index (YI) change as a function of sterilization dose, colorant type & colorant concentration. These plots provide a comparison of PVC compositions prepared with (a) inorganic, (b) organic, and (c) organometallic colorants. The plots indicate that PVC compositions with inorganic colorant retained their yellowness index after gamma radiation while PVC compositions with organic & organometallic colorants did not retain their original color following gamma radiation. FIGS. 3(a)-3(c) are the same as FIGS. 4(a)-4(c) except that the approximate yellowness index (YI) color bands are indicated by brackets in FIGS. 3(b) and 3(c). In FIG. 3(a) the Yellowness Index did not vary substantially over the range of sterilization and concentration shown, YI ranging only from about 4 to about −2.

FIGS. 4(a)-4(c) show color plots corresponding to FIGS. 3(a) to 3(c).

FIG. 5 shows a plot of PVC color change (ΔE) vs. time post-sterilization (in weeks) for molded PVC articles sterilized with 16-21 KGy Gamma radiation and aged at 40° C. comprised of (in order from top to bottom in the figure) a commercially-available, medical grade Non-DEHP PVC, a medical grade DEHP PVC, DEHP-free PVC with 100 ppm Co/Al oxide inorganic pigment, DEHP-free PVC with 50 ppm Co/Al oxide inorganic pigment.

### DETAILED DESCRIPTION

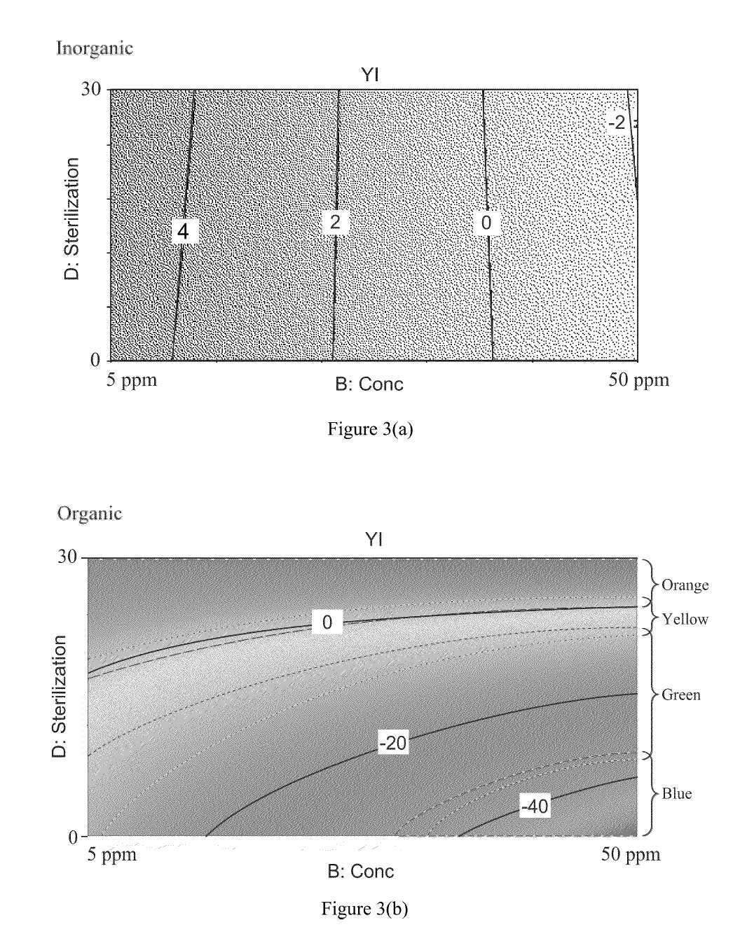

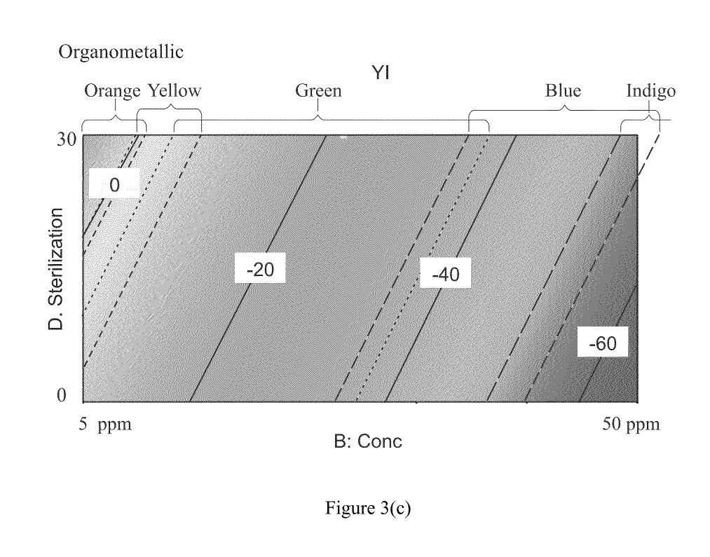

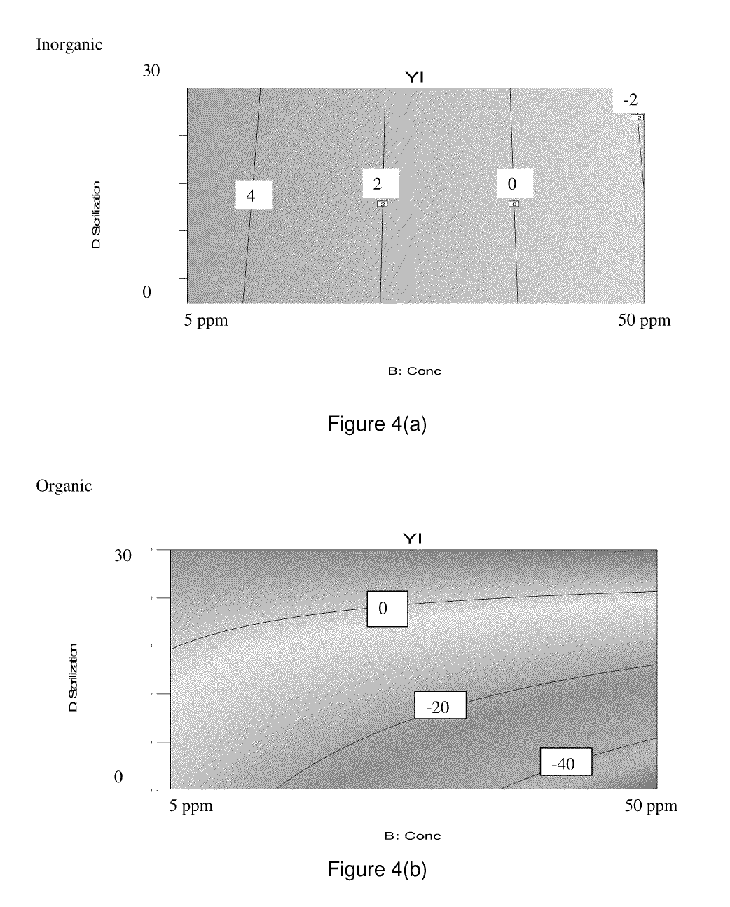

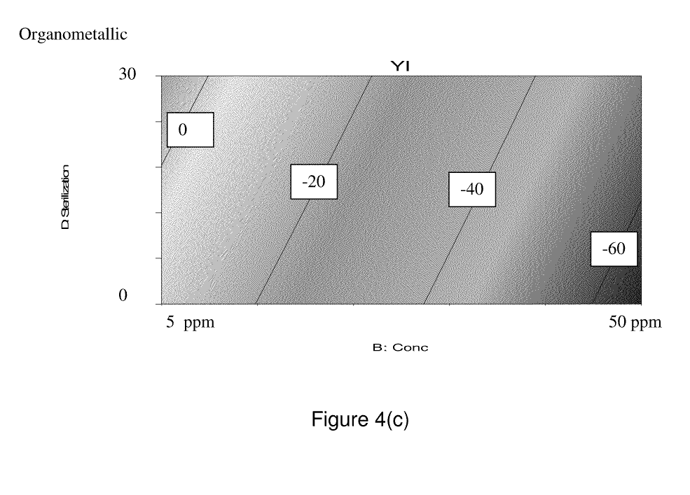

Disclosed herein are gamma-irradiated, plasticized polyvinyl chloride (PVC) articles, and methods of making the same. In one aspect, the gamma-irradiated PVC articles according to the disclosure include a PVC resin, a primary plasticizer present in an amount of about 30 to about 60 phr and a metal-carboxylate acid scavenger present in an amount of about 0.01 to about 0.5 phr. In one type of embodiment, a gamma-irradiated, plasticized PVC article further includes a secondary plasticizer present in an amount up to about 30 phr. In another, non-exclusive aspect, the PVC articles according to the disclosure include a PVC resin, a primary plasticizer present in an amount of about 25 to about 55 phr, and an inorganic colorant in an amount of at least about 0.008 phr and optionally less than about 0.15 phr, for example in a range of about 0.008 phr to 0.149 phr. Optionally, the PVC articles according to this aspect can further include a secondary plasticizer present in an amount up to about 30 phr and/or a metal-carboxylate acid scavenger present in an amount up to about 0.5 phr. In one contemplated class of embodiments the PVC article is gamma-irradiated. Optionally, the PVC articles according to the disclosure are heat processed. Further, disclosed herein are methods of making gamma-irradiated PVC articles, including the steps of providing a PVC article according to the disclosure and exposing the PVC article to gamma radiation in an amount in a range of about 10 KGy to about 100 KGy. Optionally, the method further includes heat processing the PVC mixture to form the PVC article. The gamma-sterilized PVC articles of the disclosure can be particularly advantageous in that they can be designed such that the articles are less yellow after electromagnetic irradiation, e.g. having a maximum yellowness index as described herein of 7, or 6, or 5, for example after gamma-irradiation, as measured by a colorimeter. Optionally the minimum yellow index can be −3, or −2, or −1, for example. Contemplated ranges include any combination of the foregoing and intermediate values, for example −2 to 7, −2 to 6, and −2 to 5, and −1 to 5. In one aspect of the disclosure, the PVC article can be designed such that the clarity & color of the PVC article is maintained following gamma irradiation (see FIGS. 3 and 4). Although it is known in the art that PVC articles can undergo UV bleaching to reduce the amount of yellowing after irradiation, in a further aspect of the disclosure, the PVC article can be designed such the articles are less yellow after irradiation without UV bleaching of the article.

The PVC compositions, articles, and their methods of manufacture and use are contemplated to include embodiments including any combination of one or more of the additional optional elements, features, and steps further described below (including those shown in any figures), unless stated otherwise. While the present disclosure provides PVC examples, the compositions and articles described herein can be based upon other halogenated polymers, including, but not limited to, vinylidene chloride and fluoro polymers, for example.

As used herein, the term “comprising” indicates the potential inclusion of other agents, elements, steps, or features, in addition to those specified.

As used herein and unless specified otherwise, the terms “wt. %” and “wt %” are intended to refer to the composition of the identified element in “dry” (non water) parts by weight of the entire composition (when applicable). As used herein and unless specified otherwise, the term “phr” is intended to refer to the composition of the identified element in parts per one hundred parts halogenated polymer resins, e.g. polyvinyl chloride (PVC) resin.

Polyvinyl chloride compositions, optional ingredients for use therein, and methods of making the same are well known in the art.

PVC resins suitable for use in PVC articles of the disclosure include medical-grade and food-grade polyvinyl chloride homopolymers, available, for example, from OxyVinyls, LP (Dallas, Tex.). The PVC resin can be included in the composition in any suitable amount, for example an amount in a range of about 35 wt % to about 90 wt %. The preferred weight ratio of the amount of the PVC resin as compared to the combined amount of all additives can be any suitable ratio, for example a ratio in a range of about 0.5 to about 5, or about 1 to 3, or about 1 to 2.

The K value of PVC is correlated with the molecular weight of PVC and is often used as a proxy for molecular weight. PVC resins for use in the compositions described herein can be characterized by any suitable K value for the desired PVC article end use as is already known in the art, optionally a K value in a range of about 35 to about 80, optionally in a range of about 60 to about 80, for example 70.

Acid Scavengers

Acid scavengers will be evident to the person of ordinary skill in the art in view of the present disclosure. Metal salt and metal oxide (such as MgO, ZnO, CaO, etc.) acid scavengers are commonly added to PVC compositions to stabilize the compositions to heat and radiation during both the formation of PVC articles and the long-term storage of PVC articles. Suitable acid scavengers can be selected from those already known in the art. For example, suitable acid scavengers for use in compositions according to the disclosure can include alkaline metal carboxylates, including but not limited to, metal stearates, metal palmitates, metal salts of other C₁₄-C₂₀ fatty acetates, and combinations thereof. Suitable metals for use herein include, but are not limited to, Zn, Ca, Cd, Ba, Al, Pb and combinations thereof. Without intending to be bound by theory, it is believed that the ZnCl₂ formed by the reaction of a zinc carboxylate with HCl can act as a catalyst towards further dehydrochlorination, if there is no secondary metal carboxylate present to regenerate the zinc carboxylate. In one type of embodiment, the acid scavenger will not include zinc carboxylates. In another type of embodiment, the acid scavenger comprises two or more metal carboxylates. In another contemplated embodiment, wherein the acid scavenger comprises two or more metal carboxylates, one of the two or more metal carboxylates is a zinc carboxylate. In one class of embodiments, the acid scavenger comprises a combination of calcium carboxylate and zinc carboxylate. In a further class of embodiments, the acid scavenger comprises a combination of calcium stearate and zinc stearate. In a further class of embodiments, the acid scavenger consists only of a zinc stearate. Prior to the present invention, it was assumed by those of skill in the art that increase in acid scavenger concentration and reduction of the acid forming during poly(vinyl chloride) processing-lead degradation lead to reduction of color indicating polymer degradation. The work of the present inventors demonstrated unexpected results, that the foregoing assertion was not correct for thermoformed poly(vinyl chloride) parts that undergo radiation sterilization.

The amount of the acid scavengers incorporated into the composition can be less than 0.5 phr, for example in a range of about 0.01 to about 0.5 phr, or about 0.01 to 0.49 phr, or 0.01 to 0.45 phr. In the alternative, the amount of acid scavenger incorporated into a composition can be defined by the relative amount of acid scavenger to primary plasticizer, as measured by their FTIR peak intensities. For example, the characteristic IR peak for Ca/Zn stearate is 1540 cm⁻¹ and the characteristic IR absorption peak for aromatic type plasticizer is 1600 cm⁻¹. In one contemplated class of embodiments the acid scavenger to primary plasticizer ratio is less than 0.2, or less than 0.1, or less than 0.05, or less than 0.01. In view of the present disclosure, those of ordinary skill in the art will appreciate that the amount of acid scavenger necessary to provide stabilization to gamma irradiation can vary depending on the type of plasticizer included in the composition. Some plasticizers, for example, epoxidized oils, protect PVC from thermal and gamma radiation-induced discoloration while others, for example, diethylhexylphthalate offer no protection. Without intending to be bound by any particular theory, it is believed that the acid scavenger, such as epoxy-group containing compounds or alkaline earth metal salts (Mg, Zn, Al, Ca, etc.) stabilizes the PVC to discoloration caused by high temperature or by gamma-radiation exposure. It is believed that discoloration of PVC is caused by the formation of conjugated polyenes forming due to dehydrochlorination of the PVC resin. Further, it is believed that the hydrochloric acid (HCl) formed from the dehydrochlorination of the PVC autocatalyzes further release of HCl. Accordingly, a common approach to prevent yellowing of a PVC articles, which are to be formed with heating and then exposed to gamma radiation, has been to increase the amount of acid scavenger included in a PVC composition. Surprisingly, it has been found that even in the presence of epoxidized oil plasticizer increase in metal salt stabilizer may lead to stronger color formation. Thus, it is advantageous to limit the amount of metal salt acid scavenger incorporated into the PVC composition, e.g. to less than levels found in typical commercial PVC (e.g., to less than 0.5 phr). This applies to PVC formulations containing trimellitate, or DEHP and epoxydized oil plasticizers.

In one contemplated class of embodiments, the PVC composition includes less than 0.5 phr acid scavenger and does not include secondary stabilizers. Without intending to be bound by theory, it is believed that in this class of embodiments, the HCl released upon thermal forming of PVC and subsequent gamma radiation may undergo radiation-induced radical decomposition. It is believed that the resulting chlorine and hydrogen radicals can react with the double bonds of the PVC, removing conjugation and reducing coloration of the partially-degraded PVC.

Inorganic Colorants

In another, non-exclusive aspect of the invention, the PVC compositions herein include one or more inorganic colorants. In one type of embodiment, the inorganic colorant is an inorganic pigment. The inclusion of inorganic colorants into PVC compositions can stabilize the PVC compositions against color change upon molding of PVC articles and also upon exposure of a PVC article to gamma radiation. Inorganic colorants can be included in a PVC composition in an amount of about 5 ppm to about 50 ppm or 100 ppm, for example. Suitable inorganic colorants include metal oxides, and may include one or more different metals. Optionally the inorganic colorant is a ternary oxide. Suitable metals for inorganic colorants include, but are not limited to, the transition metals and metals of groups IIA, IIIB, and IVB. In one type of embodiment, the inorganic colorant is blue in color. In another type of embodiment, the inorganic colorant is purple in color. Inorganic colorants may be included in the PVC composition in an amount in the range of about 0.01 phr to about 0.5 phr, or about 0.01 phr to about 0.1 phr, or about 0.01 phr to about 0.05 phr, or about 0.04 phr. Inorganic pigments may be included in the PVC composition in an amount of at least 0.008 phr and optionally less than 0.15 phr, or in a range of about 0.008 phr to less than 0.15 phr, for example. One of ordinary skill in the art will appreciate that the choice of metal will vary based on the concentration to be included in the composition. For example, it has been found that organometallic colorants provide higher intensity of color than inorganic colorants when used at the same colorant concentration. Also, transparency may be lost when the inorganic colorants are used at high amount where organic colorants would still retain transparency.

During gamma irradiation, pigments and dyes are ionized, which may result in degradation and/or reaction with the polymer matrix, plasticizer, and other radicals and/or ions formed during exposure of the PVC article to gamma radiation. Surprisingly, in one class of embodiments, PVC compositions that include an inorganic colorant maintain almost invariant coloration and appearance after gamma irradiation. In contrast, PVC compositions with organic colorants are initially colored and undergo a color change during exposure to gamma radiation, and accelerated aging. Moreover, PVC compositions with organometallic colorants are initially colored and either undergo a color change or maintain their color during exposure to gamma radiation, however they cannot retain the same color upon accelerated aging after gamma irradiation. Blue organic and organometallic colorants (pigments and dyes) are added to PVC compositions to mask the yellow color formation that occurs upon exposure to heat and/or radiation and/or accelerated aging. However, these pigments and dyes may degrade under radiation exposure or accelerated aging, resulting in color change. Accordingly, PVC articles that include organic or organometallic colorants are colored either pre-gamma radiation or post-gamma radiation, and often both. Advantageously, unlike the PVC compositions that include organic or organometallic colorants, the PVC compositions described herein can be designed to maintain their color and appearance before and after irradiation and can therefore be used both in applications that require the PVC to undergo gamma radiation sterilization and applications that do not. Advantageously, unlike PVC compositions that include organic and organometallic colorants, irradiated PVC articles according to the disclosure that include inorganic colorants also exhibit long term color stability, up to 17 weeks, as determined by accelerated aging studies of post-gamma irradiated (27 KGy) articles at 57° C.

Without intending to be bound by theory, it is believed that inorganic colorants (pigments) stabilize PVC to gamma radiation by one or both of two mechanisms. First, it is believed that the inorganic pigment acts as an acid scavenger thereby reducing the amount of HCl available for autocatalysis of dehydrochlorination of the PVC which leads to formation of colored conjugated polyenes. Second, it is believed that the inorganic pigment can terminate radicals that are formed or which would otherwise be formed during gamma irradiation. Inhibition of PVC degradation by transition metals and their compounds may start at the early stages of gamma radiation and lead to prevention of organic, and hydrogen and chlorine radicals formation.

The PVC compositions according to the disclosure can include other optional additive ingredients including, but not limited to, plasticizers, lubricants, impact modifiers, biocides, fillers, colorants, antioxidants, and other functional ingredients, for example in amounts suitable for their intended purpose.

The PVC compositions according to the disclosure can include a primary and, optionally, a secondary plasticizer. Plasticizers for use in PVC compositions are well known in the art. Suitable plasticizers for use as a primary or secondary plasticizer include phthalate plasticizers, for example di-2-ethylhexylphthalate (DEHP), di(2-ethylhexyl) terephthalate (DEHT), di-butylphthalate (DBP), di-isobutylphthalate (DIBP), butyl benzylphthalate (BBP), and di(isononyl)phthalate (DINP), epoxidized vegetable oils, for example, soy and linseed, trimellitates, for example, trimethyl trimellitate (TMTM), tris(2-ethylhexyl)trimellitate (TOTM), and n-octyltrimellitate (OTM), polyesters, phosphates, for example, isodectyl diphenyl phosphate (DDP) and tris(2-ethylhexyl) phosphate (TOF), citrates, for example, butyryl trihexyl citrate (BTHC) and acetyl tributyl citrate (ATBC), benzoates, for example dipropylene glycol dibenzoate (DPGDP), sulphonates, for example, phenyl cresyl esters of pentadecyl sulfonic acid, carboxylates, cyclohexane based, such as di(isononyl)cyclohexane-1,2-dicarboxylate, castor oil derivatives, and adipates, for example, di-2-ethylhexyladipate (DEHA), dimethyladipate (DMAD), and dioctyladipate (DOA).

The primary plasticizers can be included in the PVC compositions in any suitable amount, for example in a range of about 30 phr to about 70 phr, or from about 35 phr to about 65 phr, or from about 30 phr to about 60 phr, or from about 25 phr to about 55 phr. In some embodiments, the PVC compositions will include a secondary plasticizer. A secondary plasticizer can be included in the PVC composition in any suitable amount, for example, up to about 30 phr. As less plasticizer is used, the PVC articles can become more brittle, whereas as more plasticizer is used the PVC articles can lose strength.

In one contemplated class of embodiments, the primary plasticizer is DEHP. In another contemplated class of embodiments, a PVC composition includes an inorganic colorant and a non-DEHP plasticizer, optionally, the PVC composition is free of DEHP. DEHP is a common plasticizer in PVC articles; however, DEHP-free PVC compositions are advantageous for medical or food-packaging applications in view of growing concerns over leaching of DEHP from PVC articles.

Lubricants for use in PVC compositions according to the disclosure are well known in the art. Suitable lubricants include, but are not limited to, polyethylene, paraffin wax, and acrawax, for example N,N′ ethylene bisstearamide. Lubricants can be included in the PVC compositions in an amount up to about 0.5 phr.

The PVC compositions described herein can be formed into PVC articles. PVC articles can be made using any suitable equipment and method, including the various methods already commonly known in the art. The PVC articles can be heat-processed. For example, the PVC article can be made with one or more processing steps including, but not limited to, extrusion, extrusion blow molding, injection molding, injection blow molding, insert molding, rotational molding, thermoforming, vacuum forming, pultrusion, resin transfer molding, and welding.

The PVC articles for use herein can have a thickness (e.g., at their thinnest point or in another embodiment measured by average thickness) in any desired range, including values in a range of about 0.5 mm to about 10 mm, or about 0.5 mm to about 5 mm, or about 0.5 mm to about 2 mm, or about 1 mm, for example. Without intending to be bound by theory, it is believed that for thin films, e.g., about 0.1 mm thick, the HCl formed by dehydrochlorination diffuses quickly out of the PVC article and is therefore unavailable for autocatalyzing further decomposition. Thus, the advantages of the invention are more pronounced with articles thicker than 0.1 mm.

The irradiated PVC articles of the disclosure (e.g. gamma-irradiated articles) can characterized by a maximum yellowness index as described herein of 7, or 6, or 5, for example. Optionally the minimum yellow index can be −3, or −2, or −1, for example. Contemplated ranges include any combination of the foregoing and intermediate values, for example −2 to 7, −2 to 6, and −2 to 5, and −1 to 5. In another aspect, the maximum change in YI for gamma-irradiated PVC articles of the disclosure (at least 25 KGy dose) optionally can be 3 or less, or 2 or less, or 1 or less for example about 0.7 or less. Further optionally, the irradiated PVC article can have a net color change of less than 5 ΔE, or less than 4 ΔE, or less than 3 ΔE, or no greater than about 2 ΔE, or less than about 2 ΔE, after aging about 15 weeks. For example, the irradiated PVC article can have such net color change limits when sterilized with 27 KGy Gamma radiation and then aged for 15 weeks at 57° C. In another embodiment, the irradiated PVC article can have such net color change limits when sterilized with 16-21 KGy Gamma radiation and aged at 40° C. for 8 weeks.

One aspect of the disclosure is a method of making a gamma-irradiated PVC article. In one contemplated class of embodiments, the method of making the gamma-irradiated PVC article includes the steps of:

(a) providing a PVC article including a mixture of a PVC resin, a primary plasticizer present in an amount of about 30-60 phr and a metal-carboxylate acid scavenger present in an amount of about 0.01 to about 0.5 phr; and
(b) exposing the PVC article to gamma radiation in an amount in a range of about 10 KGy to about 100 KGy, or about 20 KGy to about 90 KGy, or at least about 20, 25, 30, 35, 40, 45, 50, 55, 60, 65, 70, 75, 80, 85, 90, 95 or 100 KGy. Optionally, the method further includes heat processing the PVC mixture to form the PVC article.

In another contemplated class of embodiments, the method of making the gamma-irradiated PVC article includes the steps of:

(a) providing a PVC article including a mixture of a PVC resin, a primary plasticizer present in an amount of about 30 to about 60 phr, and an inorganic colorant in an amount in a range of about 0.008 phr to less than about 0.15 phr; and
(b) exposing the PVC article to gamma radiation in an amount in a range of about 10 KGy to about 100 KGy, or about 20 KGy to about 90 KGy, or at least about 20, 25, 30, 35, 40, 45, 50, 55, 60, 65, 70, 75, 80, 85, 90, 95 or 100 KGy. Optionally, the method further includes heat processing the PVC mixture to form the PVC article.

The PVC articles in accordance with the disclosure can be better understood in light of the following examples, which are merely intended to illustrate the PVC compositions and articles and are not meant to limit the scope thereof in any way.

### Examples

### Colorimetric Measurement

The colorimeter is configured to measure the color in Hunter Lab space in total transmission mode using a 1″ large area view (TTranLAV), D65/10 Illuminant/observer, and standardized using a reference standard for white and a light trap for black. A white fixture or sample holder, custom-made to the shape of the part, is then installed into the colorimeter; the color of the fixture is measured and is set as the background color to be subtracted from the color of the measured part. The parts are measured individually. Color is measured using the standard Hunter Lab measurements. ASTM D2244-07 provides the most comparable methods to the technique used.

The direction of the color difference is described by the magnitude and algebraic signs of the components ΔL, Δa, and Δb. ΔL corresponds to the lightness of the color, where a positive value for ΔL corresponding to a lightening of color, and a negative value to a darkening of the color. Δa is the Red-Green value with a positive Δa corresponding to a shift towards red, and a negative value a shift toward green. Δb is the Yellow-Blue value with a positive Δb corresponding to a shift toward yellow, and a negative value a shift toward blue. ΔE is used as a single value to represent overall color, it is the magnitude of the value of color in the three dimensional space. For all values presented (ΔE, ΔL, Δa, and Δb) the shifts are measurements from the color of the fixture which has been designated 0,0,0 during the background subtraction process. The magnitude, ΔE, gives no indication of the character of the difference since it does not indicate the relative quantity and direction of hue, chroma, and lightness differences. This value is calculated using the formula:

ΔE=\sqrt{ΔL²+Δa²+Δb²}.

Traditionally, yellowness index (YI) is used as an indicator for monitoring the change in yellow color due to specific concerns with PVC particles becoming yellower. Yellowness index measurements were made in reflectance mode using the same instrument, standard white fixture (sample holder) and testing parameters aforementioned. Yellowness Index per ASTM Method E313 scale [D65 illuminant/2°] was selected for reporting yellowness index, according to the following formula:

$$Y I E 313 = \frac{100 ( {C}_{x} X - {C}_{z} Z )}{Y}$$

wherein Cx=1.2985 and Cz=1.1335 (D65/2° coefficients), and X, Y, and Z are the CIE Tristimulus values. Higher values of YI indicated samples which were more yellow.

### Example 1

### Zn/Ca Stearate Level

PVC molded articles were prepared from commercially available medical grade PVC compositions obtained from a PVC compounder. The molded articles were prepared using four different PVC compositions that included PVC resin, di(2-ethylhexyl) phthalate (DEHP) plasticizer, an epoxidized oil secondary plasticizer, and an acid scavenger comprising Ca/Zn stearate. The level of DEHP plasticizer was constant across PVC compositions. The level of Ca/Zn stearate was varied, and the four PVC compositions were characterized by stearate:DEHP ratios of 0.04, 0.18, 0.20, and 0.60, as measured by FTIR peak intensity. The PVC molded articles were exposed to 27 KGy of gamma irradiation. The change in color of the PVC molded articles was determined by a colorimeter.

The results are shown in Table 1. The magnitude of color change (increase in the ΔE relative to white) of the 0.04, 0.18, 0.20, and 0.60 molded articles was 5.73, 6.89, 7.26, and 10.26, respectively. This example demonstrates that upon exposure to gamma radiation, the degree of color change of the molded article is positively correlated with the amount of Zn/Ca stearate included in the PVC composition.

TABLE 1

| | 1 | 2 | 3 | 4 |
|---|---|---|---|---|
| FTIR Ca/Zn | 0.04 | 0.18 | 0.20 | 0.60 |
| stearate:aromatic | | | | |
| type plasticizer | | | | |
| peak height ratio | | | | |
| [0025] | | | | |
| ΔE [0043], | 5.73 | 6.89* | 7.26* | 10.26* |
| relative to white | | | | |

[*Average of the runs from two different PVC molds]

### Example 2

### Inorganic Pigments

PVC molded articles were prepared from PVC compositions comprising PVC resin, a DEHP free primary plasticizer, an epoxidized oleic acid secondary plasticizer, Zn stearate, and a Co/Al oxide inorganic pigment. The inorganic pigments were included in the compositions at a level of either 5 ppm or 50 ppm. PVC molded articles prepared from both compositions were initially colorless. The PVC molded articles were exposed to 25 KGy gamma radiation. The PVC molded articles prepared from both PVC compositions retained their original color after exposure to gamma radiation (Table 2). This example demonstrates the color stability of PVC compositions including inorganic pigments. YI of the compositions was improved with the addition of inorganic colorants, as compared to compositions with no colorant, and no change in yellowness was observed following gamma sterilization.

TABLE 2
Color Parameters (average of 5 measurements)

| | | |
|---|---|---|
| PVC Composition with | YI | ΔE |

Pre-Gamma

| | | |
|---|---|---|
| Inorganic at 5 ppm | 4.95 | 3.26 |
| Inorganic at 50 ppm | −1.03 | 1.98 |
| No colorant | 7.15 | 4.28 |

Post-Gamma

| | | |
|---|---|---|
| Inorganic at 5 ppm | 4.98 | 2.65 |
| Inorganic at 50 ppm | −1.77 | 1.22 |
| No colorant | 10.54 | 4.76 |

### Comparative Example 3

### Organic Pigments

PVC molded articles were prepared from PVC compositions comprising PVC resin, a DEHP free primary plasticizer, an epoxidized oleic acid secondary plasticizer, Zn stearate, and an organic colorant comprised of 1-hydroxy-4-[(4-methyphenyl)amino)]anthracene-9,10-dione. The organic colorants were included in the compositions at a level of either 5 ppm or 50 ppm. PVC molded articles prepared from both compositions were initially blue. The PVC molded articles were exposed to 25 KGy gamma radiation. The PVC molded articles prepared from 50 ppm PVC composition were yellowish-red after exposure to gamma radiation while molded articles prepared from 5 ppm PVC composition didn't retain its original color. This example demonstrates the effect of gamma radiation on the color of PVC compositions including organic pigments.

TABLE 3
Color Parameters (average of 5 measurements)

| | | |
|---|---|---|
| PVC Composition with | YI | ΔE |

Pre-Gamma

| | | |
|---|---|---|
| Organic at 5 ppm | −8.72 | 3.93 |
| Organic at 50 ppm | −54.16 | 21.09 |

Post-Gamma

| | | |
|---|---|---|
| Organic at 5 ppm | 7.53 | 3.09 |
| Organic at 50 ppm | 18.06 | 9.26 |

### Comparative Example 4

### Organometallic Colorant

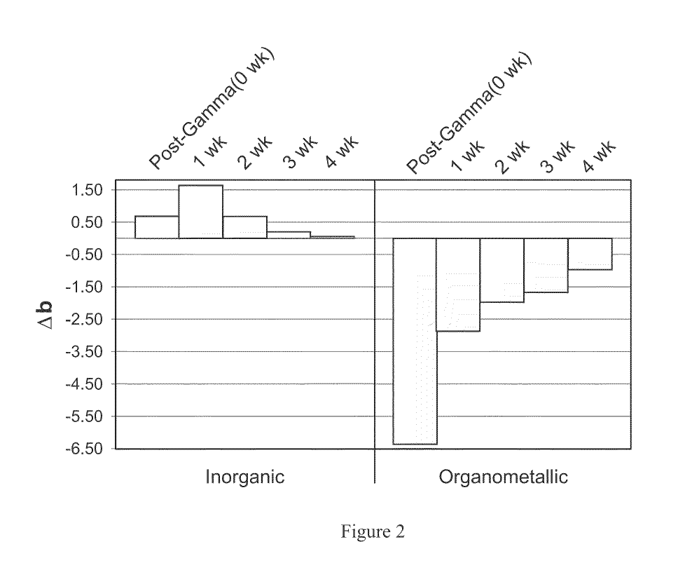

PVC molded articles were prepared from PVC compositions comprising PVC resin, a DEHP free primary plasticizer, an epoxidized oleic acid secondary plasticizer, Zn stearate, and a Cu-phthalocyanine beta organometallic pigment (Cu organic). The organometallic pigments were included in the compositions at a level of either 5 ppm or 50 ppm. The PVC molded articles were exposed to 27 Kgy gamma radiation. The PVC molded articles were subjected to accelerated aging at 57° C. The PVC molded articles that included 50 ppm organometallic colorant showed no visual color change following accelerated aging while PVC molded articles that included 5 ppm organometallic colorant showed color change following gamma irradiation (Table 4). The color stability of the molded PVC articles following accelerated aging after gamma irradiation is shown in FIG. 2. FIG. 2 provides comparison of the change in yellow-blue color index, Δb, as a function of accelerated aging time. Even though PVC compositions made with 50 ppm organometallic colorant provided blue color initially (negative Δb value) they became yellower over time, while PVC compositions with inorganic colorant retained their original color upon accelerated aging.

TABLE 4
Color Parameters (average of 5 measurements)

| | | |
|---|---|---|
| PVC Composition with | YI | ΔE |

Pre-Gamma

| | | |
|---|---|---|
| Organometallic at 5 ppm | −7.78 | 4.58 |
| Organometallic at 50 ppm | −65.0 | 16.2 |

Post-Gamma

| | | |
|---|---|---|
| Organometallic at 5 ppm | 5.62 | 2.97 |
| Organometallic at 50 ppm | −49.6 | 13.5 |

### Comparative Example 5

### Accelerated Aging

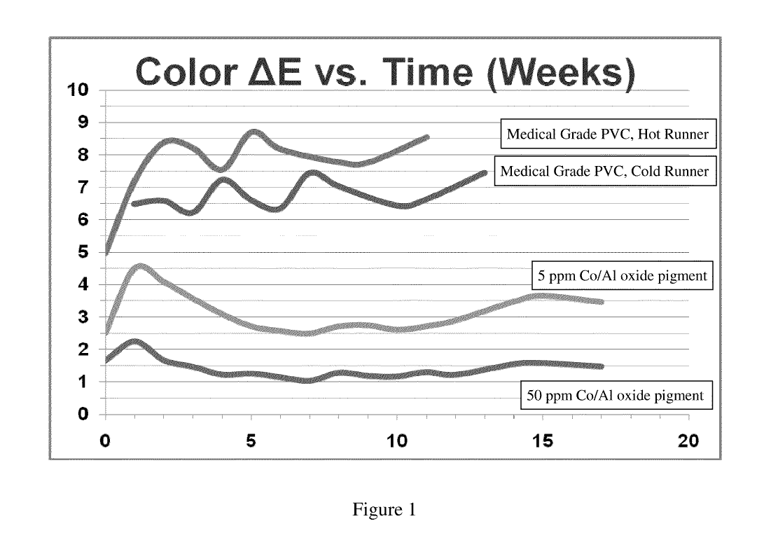

PVC molded articles were prepared from PVC compositions comprising PVC resin, a DEHP free primary plasticizer, an epoxidized oleic acid secondary plasticizer, Zn stearate, and a Co/Al oxide inorganic pigment. The inorganic pigments were included in the compositions at a level of either 5 ppm (aqua line) or 50 ppm (purple line) (FIG. 1). PVC molded articles were also prepared from commercially available PVC compositions. The commercially available PVC compositions included PVC resin, DEHP, and Ca/Zn stearate. The stearate:aromatic type plasticizer ratio in the commercial PVC formulation was 0.2, as measured by FTIR peak intensity. The PVC molded articles were exposed to 27 KGy gamma radiation. The PVC molded articles were subjected to accelerated aging at 57° C. The color stability of the molded PVC articles is shown in FIG. 1. The PVC molded articles that included an inorganic colorant showed improved color stability over the commercially available PVC.

### Comparative Example 6

### Accelerated Aging

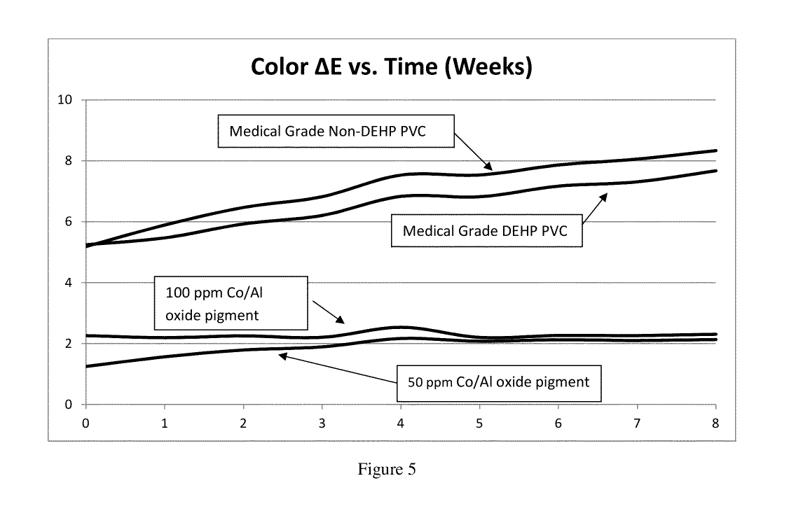

PVC molded articles were prepared from PVC compositions comprising PVC resin, a DEHP free primary plasticizer, an epoxidized vegetable oil secondary plasticizer, Zn stearate, and a Co/Al oxide inorganic pigment. The inorganic pigments were included in the compositions at a level of either 50 ppm or 100 ppm (FIG. 5). PVC molded articles were also prepared from commercially available, medical grade PVC compositions. The commercially available PVC compositions included PVC resin and Ca/Zn stearate (top line) or PVC resin, DEHP, and Ca/Zn stearate (second line from top) (FIG. 5). The stearate:aromatic type plasticizer ratio in the commercial PVC formulations was 0.2, as measured by FTIR peak intensity. The PVC molded articles were drip chamber housings. Drip chambers were assembled and then administration sets were assembled, packaged and exposed to 16-21 KGy gamma radiation. The PVC molded articles were subjected to accelerated aging at 40° C. The color stability of the molded PVC articles is shown in FIG. 5. The PVC molded articles that included an inorganic colorant showed improved color stability over the commercially available PVC.

1. A polyvinyl chloride (PVC) article, comprising: a gamma-irradiated PVC article comprising a mixture of
a PVC resin;
a primary plasticizer present in an amount of about 30 to about 60 parts per hundred parts resin (phr); and
a metal-carboxylate acid scavenger present in an amount of about 0.01 to about 0.5 phr.

2. The PVC article according to claim 1, wherein the PVC article is a heat-processed PVC article.

3. The PVC article according to claim 1, further comprising a secondary plasticizer.

4. The PVC article according to claim 3, wherein the secondary plasticizer is present in an amount of up to about 30 phr.

5. The PVC article according to claim 1, wherein the primary plasticizer is selected from the group consisting of phthalates, including but not limited to di-2-ethylhexylphthalate (DEHP), di(2-ethylhexyl) terephthalate (DEHT), di-butylphthalate (DBP), di-isobutylphthalate (DIBP), butyl benzylphthalate (BBP), and di(isononyl)phthalate (DINP), epoxidized vegetable oils, for example, soy and linseed, trimellitates, for example, trimethyl trimellitate (TMTM), tris(2-ethylhexyl)trimellitate (TOTM), and n-octyltrimellitate (OTM), polyesters, phosphates, including but not limited to isodectyl diphenyl phosphate (DDP) and tris(2-ethylhexyl) phosphate (TOF), citrates, including but not limited to butyryl trihexyl citrate (BTHC) and acetyl tributyl citrate (ATBC), benzoates, including but not limited to dipropylene glycol dibenzoate (DPGDP), sulphonates, including but not limited to phenyl cresyl esters of pentadecyl sulfonic acid, carboxylates, cyclohexane based, including but not limited to di(isononyl)cyclohexane-1,2-dicarboxylate, castor oil derivatives, and adipates, including but not limited to di-2-ethylhexyladipate (DEHA), dimethyladipate (DMAD), dioctyladipate (DOA), and combinations thereof.

6. The PVC article according to claim 3, wherein the secondary plasticizer is selected from the group consisting of phthalates, including but not limited to di-2-ethylhexylphthalate (DEHP), di(2-ethylhexyl) terephthalate (DEHT), di-butylphthalate (DBP), di-isobutylphthalate (DIBP), butyl benzylphthalate (BBP), and di(isononyl)phthalate (DINP), epoxidized vegetable oils, including but not limited to soy and linseed, trimellitates, including but not limited to trimethyl trimellitate (TMTM), tris(2-ethylhexyl)trimellitate (TOTM), and n-octyltrimellitate (OTM), polyesters, phosphates, including but not limited to butyryl trihexyl citrate (BTHC) and acetyl tributyl citrate (ATBC), benzoates, including but not limited to dipropylene glycol dibenzoate (DPGDP), sulphonates, including but not limited to phenyl cresyl esters of pentadecyl sulfonic acid, carboxylates, cyclohexane based, including but not limited to di(isononyl)cyclohexane-1,2-dicarboxylate, castor oil derivatives, and adipates, including but not limited to di-2-ethylhexyladipate (DEHA), dimethyladipate (DMAD), dioctyladipate (DOA), and combinations thereof.

7. (canceled)

8. The PVC article according to claim 1, wherein the primary plasticizer is free of epoxidized vegetable oils and trimellitates.

9. The PVC article according to claim 3, wherein the secondary plasticizer is free of epoxidized vegetable oils and trimellitates.

10. The PVC article according to claim 1, wherein the metal-carboxylate acid scavenger comprises one or more metal stearates.

11. The PVC article according to claim 10, wherein the metal-carboxylate acid scavenger comprises a combination of zinc stearate and calcium stearate.

12. The PVC article according to claim 10, wherein the metal-carboxylate acid scavenger is free of zinc stearate.

13. The PVC article according to claim 1, further comprising a lubricant.

14. The PVC article according to claim 13, wherein the lubricant is selected from the group consisting of polyethylene, paraffin wax, acrawax, and combinations thereof.

15. The PVC article according to claim 13, wherein the lubricant is included in the PVC article in an amount up to about 0.5 phr.

16. The PVC article according to claim 1, wherein the PVC article has a thickness in a range of about 0.5 mm to about 10 mm.

17. (canceled)

18. (canceled)

19. The PVC article according to claim 1, wherein the PVC article has a color characterized by a yellowness index according to ASTM E313 [D65/2°] in a range of about −2.0 to about 5.0.

20. The PVC article according to claim 1, wherein the change in yellowness index according to ASTM E313 [D65/2°] of the PVC article following 25 KGy gamma irradiation is 3 or less.

21. A method of making a gamma-irradiated, plasticized PVC article, comprising:
providing a PVC article comprising a mixture of a PVC resin, a primary plasticizer present in an amount of about 30 phr to about 60 phr and a metal-carboxylate acid scavenger present in an amount of about 0.01 to about 0.5 phr; and
exposing the PVC article to gamma radiation in an amount in a range of about 10 KGy to about 100 KGy.

22. (canceled)

23. (canceled)

24. (canceled)

25. (canceled)

26. A polyvinyl chloride (PVC) article, comprising: a PVC article comprising a mixture of
a PVC resin;
a primary plasticizer present in an amount of about 25 to about 55 parts per hundred parts resin (phr); and
an inorganic pigment present in an amount of about 0.008 phr to less than 0.15 phr.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. A method of making a gamma-irradiated, plasticized PVC article, comprising:
providing a PVC article including a mixture of a PVC resin, a primary plasticizer present in an amount of about 30 to about 60 phr, and an inorganic colorant in an amount of about 0.01 to about 0.05 phr; and
exposing the PVC article to gamma radiation in an amount in a range of about 10 KGy about 100 KGy.

51. (canceled)

52. (canceled)

53. (canceled)

54. (canceled)
